(19) United States
(12) Patent Application Publication
(10) Pub. No.: US 2006/0075226 A1
(43) Pub. Date: Apr. 6, 2006

(54) Data file including encrypted content

(75) Inventors: Emre Baris Aksu, Tampere (FI); Sami Pippuri, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/238,665

(22) Filed: Sep. 28, 2005

(30) Foreign Application Priority Data
Sep. 29, 2004 (WO) PCT/IB04/03162

(51) Int. Cl. H04L 9/00

(52) U.S. Cl. 713/165

(57) ABSTRACT

A method for assembling a data file 10, 20 including encrypted content and a rights object 18, 26 enabling at least one electronic device 35 to decrypt the encrypted content. In order to enable a fast access to the rights object, the method comprises inserting an offset descriptor 51 into the data file. The offset descriptor includes an indication of an offset at least of the portion 17, 25 of the data file comprising the rights object. A further method comprises at the at least one electronic device 35 receiving the data file from a content provider 31, evaluating the offset descriptor during a continued reception of the data file, and requesting the content provider to provide immediately a portion of the data file beginning at the offset.

### FIELD OF THE INVENTION

The invention relates to a method for assembling a data file including encrypted content and a rights object enabling at least one electronic device to decrypt the encrypted content, and to a method for processing such a data file. The invention relates equally to corresponding processing components, to electronic devices and a content server comprising such processing components, and to a communication system comprising such processing components. The invention relates moreover to corresponding software codes and software program products storing such software codes. Finally, the invention relates to such a data file and to a portion in such a data file.

### BACKGROUND OF THE INVENTION

Many content providers have an interest in ensuring that distributed content can only be used by authorized users.

The Open Mobile Alliance™ (OMA) specifies a digital rights management (DRM) which allows distributing content that is protected by encryption. The encrypted content can be used by means of an electronic device which is in addition in possession of a rights object (RO) generated specifically for this device. The rights object contains an encryption key which is required for decryption of the protected content by the device for which it has been generated. Encrypted content and rights object may be provided to the electronic device either together or separately.

A second version of the OMA DRM specification defines in the document “DRM Content Format Candidate Version 2.0—15 Jul. 2004, Open Mobile Alliance, OMA-DRM-DCF-V2_{—}0-20040715-C” a new content format DCF 2.0 for a data file, which supports new use cases including a domain concept. In this domain concept, a single domain rights object is bound to a group of electronic devices belonging to a domain. The domain concept thus enables a user to use a protected content with a single associated rights object by means of a plurality of electronic devices.

Moreover, two different profiles of the content format DCF 2.0 are defined.

The first profile is intended primarily for use with discrete media, like still images. A data file 10 structured in accordance with the discrete media profile DCF is presented in FIG. 1, which has been taken from the above identified document. It comprises a fixed DCF header 11 and a first OMA DRM container 12. The first OMA DRM container 12 includes DCF headers 13 with common headers 14, and in addition DRM content 15. The DRM content 15 comprises encrypted and/or non-encrypted content objects. Further OMA DRM containers 16 may follow. At the end of the file 10, a free space container 17 is provided, which may include a rights object 18. For details of the profile, reference is made to the above identified document.

The second profile is intended primarily for use with continuous media, like video. A data file 20 structured in accordance with the continuous media profile PDCF is presented in FIG. 2. The data file 20 comprises a file type 21, a movie box 22 with OMA DRM common headers 23, media data 24 with encrypted and unencrypted content data, and a free space container 24, which may include a rights object 26. For details of the profile, reference is made to the above identified document.

Both profiles support a block-by-block encryption of the content data. In both profiles, the content headers are located in front of the content data. An integrity check is not mandatory.

The profiles of the content format DCF 2.0 thus support as well progressive downloads. A progressive download is of particular interest for large audio and/or video data. A data file comprising the data may be downloaded to an electronic device and be used in this electronic device as soon as sufficient data of the file has been transmitted. That is, it is not required to wait until the entire file has been downloaded. To this end, the data has to be organized such that it is not required seeking beyond the current download position for a playback.

In general, distinct portions of a data file are referred to as containers and/or boxes.

As indicated above, either profile of the content format DCF 2.0 provides a free space box at the end of a data file, into which a rights object can be inserted. This provides easy access to the rights object and enables editing the rights object container without affecting the rest of the file. For example, a domain rights object which is associated on the one hand to an particular content and on the other hand to a particular domain may thus be inserted easily at the end of an available data file comprising this content. Any electronic device belonging to the domain and receiving the data file may then use the included domain rights object to decrypt the protected content.

However, when downloading a data file to an electronic device, the container comprising the rights object is the last one to arrive at the device. Since a playback cannot be started before the electronic device has acquired the rights object, the entire file has to be downloaded before the playback, meaning that a progressive download is prevented.

For a progressive download, it would thus be necessary to download the container comprising the rights object at an early point of time. But to this end, the exact location of this container in the data file has to be known to the electronic device. Currently, an electronic device is only able to find out the location of a rights object within a data file that is to be downloaded from a server by transmitting a rather long series of HTTP requests to the server for iterating over the data file. This approach, however, is rather time-consuming and burdens the network used by the electronic device for accessing the server.

### SUMMARY OF THE INVENTION

It is an object of the invention to enable an easy access to a rights object in a data file, without the necessity of time-consuming iterations over the file, using for instance HTTP.

For the side of a content provider, a method for assembling a data file, including encrypted content and a rights object enabling at least one electronic device to decrypt this encrypted content, is proposed. The method comprises inserting an offset descriptor into the data file. The offset descriptor includes an indication of an offset of at least one portion of the data file in the data file, wherein the at least one portion comprises the rights object.

For the side of a content provider, moreover a processing component for assembling a data file is proposed. The processing component is adapted to include into the data file encrypted content, a rights object enabling at least one electronic device to decrypt the encrypted content, and an offset descriptor. The offset descriptor includes an indication of an offset of at least one portion of the data file in the data file, wherein the at least one portion comprises the rights object.

For the side of a content provider, moreover an electronic device is proposed which comprises such a processing component. Equally, a content server is proposed which comprises such a processing component.

For the side of a content provider, moreover a software code for assembling a data file, including encrypted content and a rights object enabling at least one electronic device to decrypt the encrypted content, is proposed. When running in a processing component, the software code inserts an offset descriptor into the data file. The offset descriptor includes an indication of an offset of at least one portion of the data file in the data file, wherein the at least one portion comprises the rights object.

For the side of a content provider, finally, a software program product is proposed, which stores such a software code.

For the side of a content user, a method for processing a data file, including encrypted content, a rights object enabling at least one electronic device to decrypt the encrypted content and an offset descriptor, is proposed. The offset descriptor includes an indication of an offset of at least one portion of the data file in the data file, and the at least one portion comprises the rights object. The proposed method comprises at least one electronic device receiving the data file from a content provider, evaluating the offset descriptor during a continued reception of the data file and requesting the content provider to provide immediately a portion of the data file beginning at the offset.

For the side of a content user, moreover a processing component for processing a data file, including encrypted content, a rights object enabling at least one electronic device to decrypt the encrypted content and an offset descriptor, is proposed. The offset descriptor includes an indication of an offset of at least one portion of the data file in the data file, wherein the at least one portion comprises the rights object. The proposed processing component is adapted to receive the data file from a content provider, to evaluate the offset descriptor during a continued reception of the data file and to request the content provider to provide immediately a portion of the data file beginning at the offset.

For the side of a content user, moreover an electronic device is proposed which comprises the processing component proposed for the side of a content user.

For the side of a content user, moreover a software code for processing a data file is proposed. The data file includes encrypted content, a rights object enabling at least one electronic device to decrypt the encrypted content, and an offset descriptor. The offset descriptor includes an indication of an offset of at least one portion of the data file in the data file, and the at least one portion comprises the rights object. When running in a processing component of the at least one electronic device, the software code receives the data file from a content provider, evaluates the offset descriptor during a continued reception of the data file and requests the content provider to provide immediately a portion of the data file beginning at the offset.

For the side of a content user, moreover a software program product is proposed which stores the software code proposed for the side of a content user.

Moreover, an offset descriptor for use in a data file is proposed. The data file includes at least one portion with encrypted content and a portion with a rights object enabling at least one electronic device to decrypt the encrypted content. The offset descriptor includes an indication of an offset in the data file at least of the portion comprising the rights object.

Moreover, a data file is proposed, which comprises at least one portion with encrypted content, a portion with a rights object enabling at least one electronic device to decrypt the encrypted content and a portion with the proposed offset descriptor.

Finally, a communication system is proposed, which comprises at least one processing component proposed for the content provider side and at least one processing component proposed for the content user side.

The invention proceeds from the consideration that a direct link to a rights object in a data file could be provided. To this end, it is proposed that an offset descriptor is included at a known location in the data file. The offset descriptor includes an indication of an offset of the rights object. This indication can be made use of at a receiving end for locating the rights object and for requesting provision of a corresponding portion of the data file.

It is an advantage of the invention that by providing a direct link to a rights object, a quick location of a rights object in a data file is enabled.

This is of particular advantage for a progressive download of a file, as only one extra request is needed for starting a playback. The resulting reduced response time also improves the user experience. At the same time, a single extra request causes a minimum additional load on a network which may be used for transmitting the data file. Also the complexity of the implementation in an electronic device receiving the data file can be reduced significantly. For simpler electronic devices, it might not even be desired to implement a more complex approach for supporting a progressive download.

The direct link to a rights object may also be of advantage for other data files, which are not progressively downloaded. In particular in case of a large data file, an electronic device knows immediately where to look for an included rights object when trying to decode the protected content.

The known ISO base media file format, which is also dealt with in the document “Technology under Consideration for the ISO Base Media File Format” by the International Organization for Standardization, ISO/IEC JTC1/SC29/WG11, Coding of moving pictures and audio, MPEG2003/N6211, December 2003, already includes a file name index and an item location box, but neither provides an offset information for a rights object.

The content may comprise for example multiple media objects. It is to be understood that in the scope of this application, a content provider can be any unit providing content to another unit, not only a unit providing a content in the first place and possibly against a charge. The content provider can be for example an Internet server providing content to a user device, but it is to be understood that it could equally be a user device providing content to another user device. For instance, a home PC acting as a content provider might enable a mobile phone to download content or vice versa. A content user is a user employing an electronic device for making use of encrypted content. The electronic device can be a mobile or a stationary device. Further, it may but it does not have to be capable of a wireless communication.

In one embodiment of the invention, the offset descriptor can be used for defining the offset of various portions of a data file, not only of a portion comprising a rights object. It is up to the content packager to optimize the list for a particular use case. In one extreme, only the offset to the portion comprising the rights object is indicated, while in the other extreme, the offset to each portion of the data file is indicated. Thus, the offset descriptor can be used for example in general for an easier search among and inside of media objects.

The portion comprising the rights object may comprise for example a single rights object or a parent free box including a plurality of rights objects, each enabling another electronic device or another group of electronic devices to decrypt the encrypted content.

A rights object may further be a rights object for a single electronic device or a domain rights object enabling a group of electronic devices to decrypt the encrypted content.

In one embodiment of the invention, the offset descriptor does not include only offset information. In addition, it may include for each portion of the data file for which an indication of an offset is inserted an indication of the type of this portion and information specific to this portion.

For example, for the portion comprising the rights object, the offset descriptor may include as a portion specific information an identification of the at least one electronic device, which is able to make use of the rights object. This may be in particular an identification of a single device or of a domain. Such an identification can be used for instance for identifying a required rights object, if the rights object is included in a parents free box together with other rights objects. For the portion comprising any other data, any useful additional information may be included as a portion specific information. It may also hold for example extension boxes.

In an advantageous embodiment of the invention, the offset descriptor is arranged closer to a beginning of the data file than the rights object. The offset descriptor can be included in particular in a header section of the data file which precedes the encrypted content. Thereby, it is ensured that the location of the rights object can be determined at a particularly early point of time.

In one embodiment of the invention, the data file is structured according to a content format defined by the Open Mobile Alliance™, and the offset descriptor is arranged in an extensible header of this data file. More specifically, the data file can be structured according to the above presented discrete media profile or the above presented continuous media profile defined by the Open Mobile Alliance™ digital rights management.

The invention can be employed in particular, though not exclusively, for the above described content format DCF 2.0. Both profiles of the content format DCF 2.0 have an extensible structure, so that the proposed offset descriptor can easily be included. If a common structure is used in both cases for the offset descriptor, also interoperability problems can be avoided.

It is to be understood that any embodiment of the invention can be realized in the scope of one of the proposed methods, of one of the proposed processing components, of one of the proposed electronic devices, of the proposed content server, of the proposed communication system, of one of the proposed software codes, of one of the proposed software program products and also of the proposed offset descriptor and of the proposed data file.

### BRIEF DESCRIPTION OF THE FIGURES

Other objects and features of the present invention will become apparent from the following detailed description considered in conjunction with the accompanying drawings.

FIG. 1 is a diagram of a DCF profile as defined by OMA DRM;

FIG. 2 is a diagram of a PDCF profile as defined by OMA DRM;

FIG. 3 is a schematic diagram of a communication system according to an embodiment of the invention;

FIG. 4 is a diagram illustrating a communication between a content provider and a content user in the system of FIG. 3;

FIG. 5 is a diagram illustrating the structure of an offset descriptor box employed in the system of FIG. 3; and

FIG. 6 is a definition of the offset descriptor box of FIG. 5.

### DETAILED DESCRIPTION OF THE INVENTION

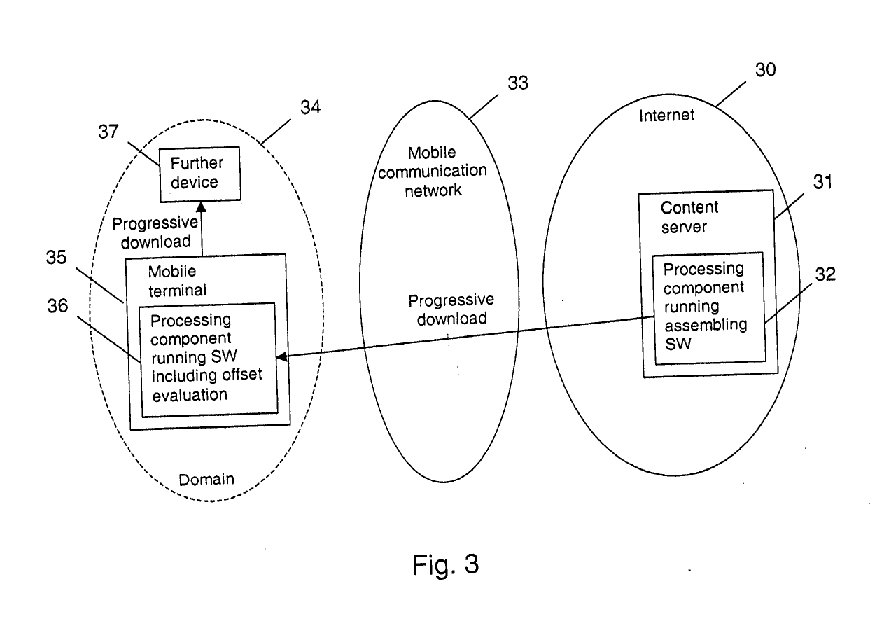

FIG. 3 is a schematic diagram of a communication system according to the invention.

The system comprises by way of example the Internet 30, a mobile communication network 33 and a domain 34.

The Internet 30 comprises a content server 31, which includes a processing component 32 running a data file assembling software code. The software code is adapted to assemble data files including protected content in accordance with the OMA DRM specification.

The mobile communication network 33 is a conventional mobile communication network 33 which enables mobile devices to access the Internet 30.

The domain 34 comprises a plurality of OMA DRM enabled electronic devices 35, 37. A common binary domain rights object for at least one protected content is provided for the electronic devices 35, 37 belonging to this domain 34. At least one of these devices 35 is a mobile terminal which is able to access the Internet 30 via the mobile communication network 33. Each of the electronic devices 35, 37 includes a processing component 36 running a content processing software code. This software code includes an offset evaluation portion.

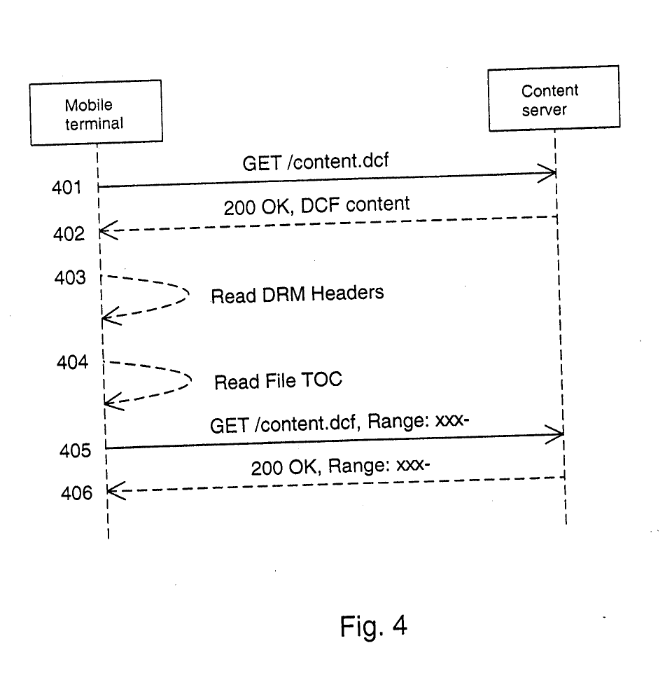

The operation in the system of FIG. 3 will now be described with reference to FIGS. 4 to 6.

FIG. 4 is a flow chart illustrating a communication between the mobile terminal 35 and the content server 31 in the system of FIG. 3.

When a mobile terminal 35 belonging to a domain 34 desires to download DCF content from a content server 31, the mobile terminal 35 transmits a HTTP request in the form of a GET message via the mobile communication network 33 and the Internet 30 to the content server 35. A parameter in the GET message indicates which DCF content is to be downloaded. (step 401)

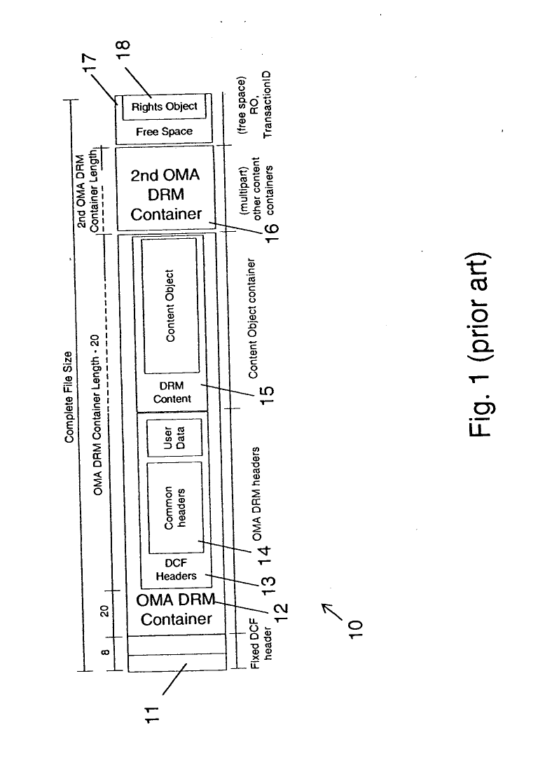

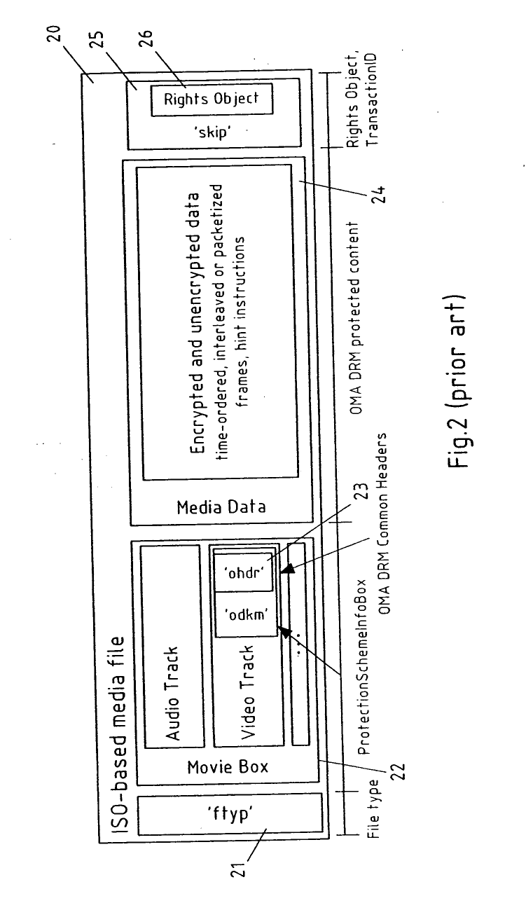

The processing component 32 of the content server 31 encrypts the requested content or receives the content in encrypted form from a content provider (not shown). The assembling software code run by the processing component 32 then assembles a data file 10, 20 comprising the protected content in accordance with the OMA DRM specification, using the DCF profile as illustrated in FIG. 1 or the PDCF profile as illustrated in FIG. 2.

The processing component 32 of the content server 31 may further generate a rights object 18, 26 for the domain 34 to which the requesting mobile terminal 35 belongs, or receive a dedicated rights object 18, 26 from a rights issuer. If such a rights object 18, 26 is available, it is inserted by the assembling software code in the free space container 17, 25 at the end of the data file 10, 20, as shown in FIG. 1 or FIG. 2.

Further, the assembling software code may generate an offset descriptor box. An offset descriptor box is generated in any case, if a rights object 18, 26 is to be added to the data file 10, 20, but it may equally be generated in case data specific to some other container of the data file 10, 20 is to be provided.

If an offset descriptor box is generated, it is included in the data file 10, 20 during the assembly. More specifically, it is included as an octet-aligned box in extended headers field of the “common headers” box 14, 23.

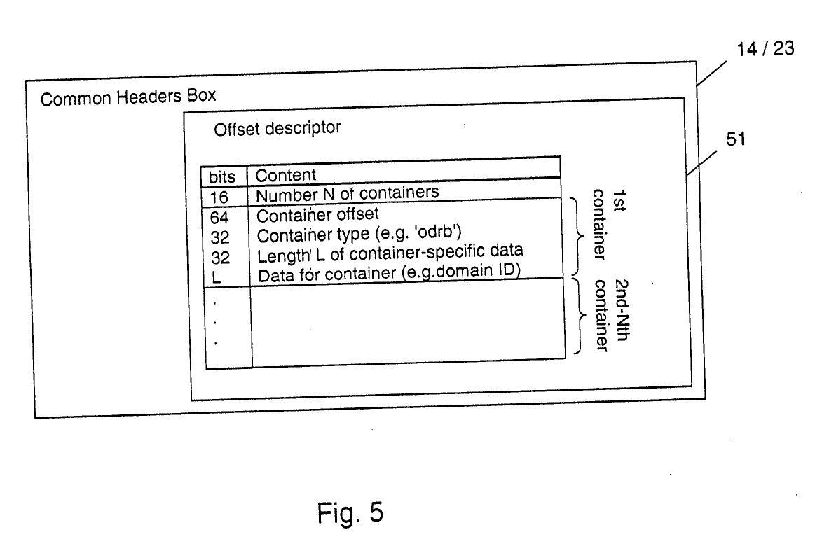

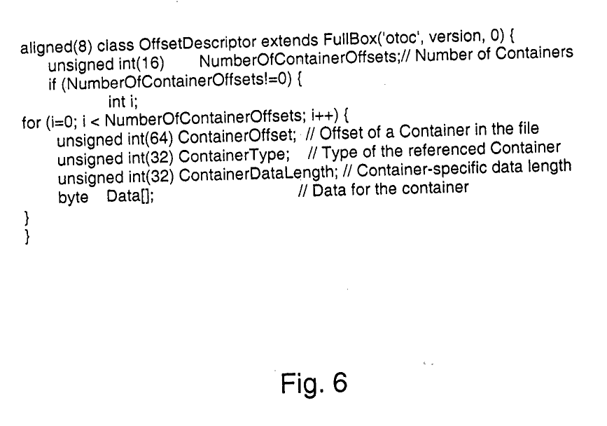

The structure of an offset descriptor box 51 which includes data for all containers of the data file 10, 20 is presented in FIG. 5. It includes a table of contents which is filled in accordance with a definition presented in FIG. 6.

The first 16 bits in the table are used for indicating the number of containers in the data file 10, 20. If there is at least one container present in the file 10, 20, a dedicated entry is generated for each present container.

For a respective container, the first 64 bits define the offset of the container in the data file. The next 32 bits define the type of the container. The next 32 bits define the length in Bytes of container-specific data. Finally, container-specific data is added using a number of Bytes, which corresponds to the length defined in the preceding 32 bits.

For the rights object 18, 26, the offset indicates the last container 17, 25 in the data file 10, 20. The container type is set to ‘odrb’. The container-specific data length defines the length of a domain ID, and the container-specific data includes the domain ID of the domain 34 to which the requesting mobile terminal 35 belongs.

Once the data file 10, 20 has been assembled, the content server 31 transmits a 200OK message to the mobile terminal 35 and starts providing the assembled data file 10, 20 (step 402).

The mobile terminal 35 starts receiving the data file 10, 20. The content processing software run by the processing component 36 of the mobile terminal 36 reads the DRM headers 13, 22 in the data file 10, 20 (step 403) and determines whether an offset descriptor box 51 is included in the extended common headers box 14, 23. If such an offset descriptor box 51 is included, the content processing software reads the table of contents in the offset descriptor box 51 (step 404). From this table, the content processing software learns whether the data file 10, 20 comprises a rights object 18, 26 and where it is located in the data file 10, 20.

If the user requested a progressive download, the mobile terminal 35 transmits thereupon a further HTTP request in form of a GET message to the content server 31 (step 405). In this message, a parameter indicates that for a particular requested DCF content, a particular range xxx- of the data file 10, 20 is to be transmitted first. This range is limited by an offset in the data file 10, 20 retrieved from the offset descriptor box 51 for a rights object 18, 26, and the end of the data file 10, 20. It corresponds thus to the free space container 17, 25 of the data file 10, 20 comprising the domain rights object 18, 26.

Upon receipt of this GET message, the processing component 32 of the content server 31 selects the defined range of the specified data file 10, 20 which is currently being transmitted to the requesting mobile terminal 35. It acknowledges acceptance of the request in the GET message with a HTTP 200 OK message and transmits the data belonging to this range immediately (step 406).

The mobile terminal 35 receives this data and the content processing software code run by the processing component 36 extracts the domain rights object 18, 26. Using the encryption key in this domain rights object 18, 26, the processing component 36 is able to decrypt the protected content in the data file 10, 20 as it arrives, and to present the decrypted content to a user while the rest of the data file 10, 20 is still being downloaded from the content server 31.

It is to be understood that the mobile terminal 35 could also simply download and store the data file 10, 20.

A further electronic device 37 belonging to the domain 34 may then request, evaluate and use the data file 10, 20 from the mobile terminal 35, just as described for the communication between the mobile terminal 35 and the content server 31. It is also possible, that the processing component 36 of the mobile terminal 35 runs a data file assembling software which assembles separately downloaded encrypted content and a domain rights object, just as described for the processing component 32 of the content server 31.

It is to be noted that the described embodiment can also be varied in many other ways and that it moreover constitutes only one of a variety of possible embodiments of the invention.

1. Method for assembling a data file (10,20) including encrypted content and a rights object (18, 26) enabling at least one electronic device (35) to decrypt said encrypted content, said method comprising inserting an offset descriptor (51) into said data file, which offset descriptor (51) includes an indication of an offset of at least one portion (17, 25) of said data file (10,20) in said data file (10,20), wherein said at least one portion (17, 25) comprises said rights object (18, 26).

2. Method according to claim 1, wherein said offset descriptor (50) includes an indication of an offset of a plurality of portions (15,16,17, 24,25) of said data file (10,20).

3. Method according to claim 1, wherein said offset descriptor (51) includes in addition for each portion of said data file (10,20) for which an indication of an offset is inserted an indication of a type of said portion and information specific to said portion.

4. Method according to claim 3, wherein for said portion (17,25) comprising said rights object (18,26), said portion specific information includes an identification of said at least one electronic device (35).

5. Method according to claim 1, wherein said portion (17,25) comprising said rights object (18,26) comprises a parent free box including a plurality of rights objects, each enabling another electronic device or another group of electronic devices to decrypt said encrypted content.

6. Method according to claim 1, wherein said rights object (18,26) is a domain rights object enabling a predetermined group of electronic devices to decrypt said encrypted content.

7. Method according to claim 1, wherein said offset descriptor (51) is arranged closer to a beginning of said data file (10,20) than said rights object (18,26).

8. Method according to claim 1, wherein said data file (10,20) is structured according to a content format defined by Open Mobile Alliance™, and wherein said offset descriptor (51) is arranged in an extensible header (14,23) of said data file (10,20).

9. Method according to claim 1, wherein said data file (10,20) is structured according to one of a discrete media profile and a continuous media profile defined by Open Mobile Alliance™ digital rights management.

10. Method for processing a data file (10,20) including encrypted content, a rights object (18,26) enabling at least one electronic device (35) to decrypt said encrypted content and an offset descriptor (51), which offset descriptor (50) includes an indication of an offset of at least one portion (17,25) of said data file (10,20) in said data file (10,20), wherein said at least one portion (17,25) comprises said rights object (18,26), said method comprising at said at least one electronic device (35) receiving said data file (10,20) from a content provider (31), evaluating said offset descriptor (51) during a continued reception of said data file (10,20) and requesting said content provider (31) to provide immediately a portion (17,25) of said data file (10,20) beginning at said offset.

11. Processing component (32) for assembling a data file (10,20), which processing component (32) is adapted to include into said data file (10,20) encrypted content, a rights object (18,26) enabling at least one electronic device (35) to decrypt said encrypted content, and an offset descriptor (51), which offset descriptor (51) includes an indication of an offset of at least one portion (17,25) of said data file (10,20) in said data file (10,20), wherein said at least one portion (17,25) comprises said rights object (18,26).

12. Electronic device (35) comprising a processing component according to claim 11.

13. Content server (31) comprising a processing component (32) according to claim 11.

14. Processing component (36) for processing a data file (10,20) including encrypted content, a rights object (18,26) enabling at least one electronic device (35) to decrypt said encrypted content and an offset descriptor (51), which offset descriptor (51) includes an indication of an offset of at least one portion (17,25) of said data file (10,20) in said data file (10,20), wherein said at least one portion (17,25) comprises said rights object (18,26), which processing component (36) is adapted to receive said data file (10,20) from a content provider (31), to evaluate said offset descriptor (51) during a continued reception of said data file (10,20) and to request said content provider (31) to provide immediately a portion (17,25) of said data file (10,20) beginning at said offset.

15. Electronic device (35) comprising a processing component (36) according to claim 14.

16. Communication system comprising at least one processing component (32) according to claim 11 and at least one processing component (36) for processing said data file, said rights object and said offset descriptor, which processing component (36) is adapted to receive said data file from a content provider (31), to evaluate said offset descriptor during a continued reception of said data file and to request said content provider to provide immediately a portion (17, 25) of said data file beginning at said offset.

17. Software code stored on a computer-readable medium for assembling a data file (10,20) including encrypted content and a rights object (18, 26) enabling at least one electronic device (35) to decrypt said encrypted content, said software code realizing the following step when running in a processing component (32):
inserting an offset descriptor (51) into said data file, which offset descriptor (51) includes an indication of an offset of at least one portion (17, 25) of said data file (10,20) in said data file (10,20), wherein said at least one portion (17, 25) comprises said rights object (18, 26).

18. Software program product storing a software code according to claim 17.

19. Software code embodied in a computer readable medium for processing a data file (10,20) including encrypted content, a rights object (18,26) enabling at least one electronic device (35) to decrypt said encrypted content and an offset descriptor (51), which offset descriptor (51) includes an indication of an offset of at least one portion (17,25) of said data file (10,20) in said data file (10,20), wherein said at least one portion (17,25) comprises said rights object (18,26), said software code realizing the following step when running in a processing component (36) of said at least one electronic device (35):
receiving said data file (10,20) from a content provider (31), evaluating said offset descriptor (51) during a continued reception of said data file (10,20) and requesting said content provider (31) to provide immediately a portion (17,25) of said data file (10,20) beginning at said offset.

20. Software program product storing a software code according to claim 19.

21. Offset descriptor (51) for use in a data file (10,20) embodied in a computer readable medium, which data file (10,20) includes at least one portion (15,24) with encrypted content and a portion (17,25) with a rights object (18,26) enabling at least one electronic device (35) to decrypt said encrypted content, said offset descriptor (51) including an indication of an offset in said data file (10,20) at least of said portion (17,25) comprising said rights object (18,26).

22. Data file (10,20) comprising at least one portion (15,24) with encrypted content, a portion (17,25) with a rights object (18,26) enabling at least one electronic device (35) to decrypt said encrypted content and a portion with an offset descriptor (51) according to claim 21.
